(19) United States
(12) Patent Application Publication
(10) Pub. No.: US 2007/0205532 A1
(43) Pub. Date: Sep. 6, 2007

(54) Functionalized composition of polyhydroxystyrene and polyhydroxystyrene derivatives and associated methods

(76) Inventor: Shawn A. McClintic, Glenville, NY (US)

Correspondence Address: SHAWN A. MCCLINTIC, GE GLOBAL RESEARCH, 34 SAINT STEPHENS LANE EAST, GLENVILLE, NY, 12302, US

(21) Appl. No.: 11/366,256

(22) Filed: Mar. 3, 2006

(51) Int. Cl. B29C 33/00; C08G 61/02

(52) U.S. Cl. 264/240; 528/86

(57) ABSTRACT

A pre-polymer composition and methods of making and using the composition are provided. The composition may include a reaction product of polyhydroxystyrene and cyanogen halide, wherein the product includes a plurality of cyanate ester moieties.

### BACKGROUND

1. TECHNICAL FIELD

The invention includes embodiments that relate to a functionalized polyhydroxystyrene or polyhydroxystyrene derivative.

2. DISCUSSION OF RELATED ART

Materials, such as polyols, may be functionalized to have reactive moieties replace, for example, relatively unreactive hydroxyl groups. Functionalized materials may be referred to interchangeably as monomers, polymers, pre-polymers, polymer precursors, and the like. Subsequent to functionalizing, the reactive groups may be activated so that they may cross link with each other, or with other reactive sites on neighboring molecules. Such activation may be referred to as curing, hardening, cross-linking, and the like.

Polymers having cyanate ester functionality may be formed by reacting an alcohol with cyanogen halide. Commercially available cyanate ester polymers may be obtained under the tradename AROCY from Ciba Specialty Chemicals, Inc. (Tarrytown, N.Y.), and XU71787 from Dow Chemical (Midland, Mich.). Low molecular weigh monomers may have correspondingly low equivalent weights, that is a relatively large number of reactive moieties per molecular weight of the molecule.

Polymers having functionality other than cyanate ester groups may include epoxides. Epoxy resins may be produced by reacting, for example, di-, tri-, and tetra-phenols and epichlorohydrin in the presence of a condensing agent such as caustic soda. Epoxy resins may be produced using polyhydroxystyrene as a polyol base. Due to a relatively large number of hydroxyl reactive sites, polyhydroxystyrene may be epoxidized to have a relatively high number of epoxy groups.

Functionalized polymers may be used to form thermoset polymers. Unfortunately, conventional thermosetting polymers may be difficult to work with, and may have one or more associated undesirable property. It would be desirable to have a polymer composition having improved properties or different properties, to allow, for example, flexibility in production and application. It would be desirable to have methods for making and using such polymer compositions.

### BRIEF DESCRIPTION

The invention includes embodiments that relate to a pre-polymer composition. The composition may include a reaction product of polyhydroxystyrene and cyanogen halide, wherein the product may include a plurality of cyanate ester moieties.

The invention includes embodiments that relate to a method of making a functionalized polyhydroxystyrene composition. The method may include mixing solutes, including polyhydroxystyrene and cyanogen halide, into a solvent to form a solution; adding a base to the solution; and, reacting the solutes to form the functionalized polyhydroxystyrene composition.

In one aspect, embodiments of the invention may provide that the solutes may further include a polyol to be added as a solute to the solution.

The invention includes embodiments that relate to a method of making a composite article in a reaction injection mold (RIM) apparatus. The method may include mixing a reaction product of polyhydroxystyrene and cyanogen halide with a catalyst to form a catalyzed cyanate ester pre-polymer; mixing the catalyzed cyanate ester pre-polymer with a curing agent in a nozzle of the RIM apparatus; and injecting the mixture of the catalyzed cyanate ester pre-polymer and curing agent into a mold of the RIM apparatus.

Other embodiments and aspects of the invention may become apparent to one of ordinary skill in the relevant art upon a reading of the specification and claims.

### DETAILED DESCRIPTION

The invention includes embodiments that relate to a functionalized polyhydroxystyrene or hydroxystyrene derivative composition. Embodiments include a polyhydroxystyrene or polyhydroxystyrene derivative having a cyanate ester reactive moiety. Embodiments include a polyhydroxystyrene or hydroxystyrene derivative having an epoxide reactive moiety. Polyhydroxystyrene and polyhydroxystyrene derivatives may be collectively referred to as polyhydroxystyrene, unless context or language indicates otherwise.

Approximating language, as used herein throughout the specification and claims, may be applied to modify any quantitative representation that could permissibly vary without resulting in a change in the basic function to which it may be related. Accordingly, a value modified by a term or terms, such as “about” and “substantially”, may be not to be limited to the precise value specified. Centipoise may be a centimeter-gram-second unit of dynamic viscosity equal to one hundredth (10⁻²) of a poise. Equivalent weight refers to molecular weight divided by the number of reactive sites per molecule. Glass transition temperature (Tg) refers to a temperature at which a polymeric material switches from a brittle vitreous state to a flexible plastic state. Melt viscosity refers to a viscosity of a material just prior to curing, where the material includes all ingredients need to form a fully cured final product. The term “novolak” refers to a phenol-formaldehyde type resin. A catalyst changes a rate of a chemical reaction without itself undergoing permanent change in composition or becoming a part of the molecular structure of the product, or markedly speeds up a cure of a compound when added in minor quantity as compared to amounts of primary reactants. A curing agent may include catalysts, and brings about polymerization when added to a resin under defined conditions (such as at a cure temperature). A cure temperature is a temperature at which a catalyzed resin, or mixture of curing agent, catalyst, and resin, begins to polymerize or cure. A polyol is a polyhydric alcohol having a plurality of pendant hydroxyl groups, and may include polyethers, glycols, polyesters, and castor oil.

A composition comprising a first embodiment of the invention may be formed from the reaction of polyhydroxystyrene with cyanogen halide, optionally in the presence of a basic compound such as triethylamine. In one embodiment, a cyanogen halide may include one or more of cyanogen chloride, cyanogen fluoride, or cyanogen bromide. A detailed description of cyanate esters and cyanate ester prepolymer production may be found in “The Chemistry and Technology of Cyanate Esters” by I. A. Hamerton, copyright 1994, Blackie Academic and Professional, an imprint of Chapman and Hall, and which is incorporated herein by reference to the extent that it discloses cyanate ester polymer production and synthesis.

Suitable production methods may include mixing a polyhydroxystyrene with a cyanogen halide to form a mixture, and, optionally, adding a base to the mixture, which may reduce or eliminate a formation of imidocarbonate, for example, by accelerating a competing reaction of phenoxide with cyanogen halide. A suitable base may include triethylamine. Additionally, a reaction temperature may be controlled to be relatively lower, and, optionally, the cyanogen halide may be selected to include cyanogen chloride.

In one embodiment, a composition may be prepared by condensation of cyanuric chloride with polyhydroxystyrene. Other cyanation methods may be suitable for use with embodiments of the invention.

Production of a cyanate ester resin or monomer having a relatively low equivalent weight may require functionalization of all, or substantially all, available hydroxyl groups (e.g., react the hydroxyl groups and replace with cyanate ester (—O—C≡N) groups. Accordingly, an excess of cyanogen chloride for each equivalent of hydroxyl may be employed. In one embodiment, an excess of less than about 2, from about 2 moles to about 5 moles, or from about 5 moles to about 10 moles of cyanogen chloride for each mole (equivalent) of available hydroxyl reactant may be used. Available hydroxyl reactant may account for stearic hindrance that may reduce or eliminate availability of a buried hydroxyl to react. For example, for high molecular weight polyhydroxystyrene a three dimensional structure may ball up or wrap around itself to effectively hide hydroxyl groups inside the molecular structure.

A base or alkali present in the reaction mixture may be an alkali metal hydroxide such as sodium, potassium or lithium hydroxide, and may be present in amount sufficient to neutralize any acid (e.g., hydrochloric acid) produced during reaction, as well as to transform a halide radical (e.g., chlorine) formed in the initial reaction of hydroxyl and cyanogen halide to a salt. In one embodiment, a suitable amount of excess may be in a range of from about 1 mole to about 4 moles of alkali per mole of total phenolic weight. To improve yields, an alkali solution may include an alcohol or organic solvent, rather than water.

Suitable polyhydroxystyrene polymers that may be used in preparing embodiments according to the invention may be represented by the following structural formulas (I), (II), and (III). Polyhydroxystyrene-PG (polymer I) may be a combination of linear styrenic and branched novolak type structures. A structure of polymer I is shown below.

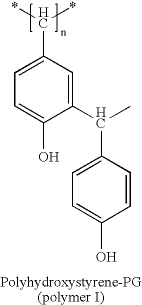

Polymer (I) may be a powder, and may have a molecular weight in a range of about 5000, or from about 4,500 to about 6,000. The variable n in the above structure may be in a range of from about 18 to about 20, from about 20 to about 28, from about 28 to about 30, or greater than about 30. Polymer (I) may have a polydispersity of less than about 2, in a range of from about 2.0 to about 2.5, from about 2.5 to about 3, or greater than about 3. Here and throughout the specification and claims range limitations may be combined and interchanged. For example, the polymer (I) may have a polydispersity in a range of from less than about 2 to greater than about 3. A glass transition temperature of polymer (I) may be in a range of from about 135 degrees Celsius to about 145 degrees Celsius

Polyhydroxystyrene novolak (polymer II) may be a branched polymer with relatively less styrenic backbone character. The structure of polymer (II) may be shown below.

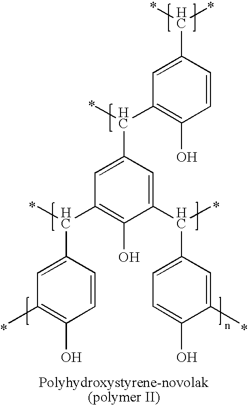

Polymer (II) may be generally in the form of a white free-flowing powder, and may be not derived from an aldehyde. Polymer (II) has a molecular weight of from about 5,400 to about 7,000, and a polydispersity of from about 1.5 to about 1.9. The variable n in the above structure typically ranges from about 10 to about 20, and from about 13 to about 17. The glass transition temperature of polymer (II) may be from about 1400 to about 145 degrees Celsius

Polyhydroxystyrene-PG-L (homopolymer of 4-ethenyl phenol) (polymer III) may be a 100% linear styrenic backbone polymer having a wide range of molecular weights from 5,000 to 60,000. The structure of polymer III may be shown below.

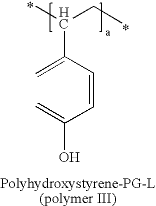

The variable n for polymer (III) may be in a range of from about 30 to about 40, from about 40 to about 100, from about 100 to about 250, from about 250 to about 500, from about 500 to about 600, or greater than about 600.

Upon the completion of a reaction according to an embodiment of the invention of one or more of the polymers (I) (II), and/or (III), a resulting functionalized polymer (monomeric) product may be formed. A composition comprising an embodiment of the invention, may be represented by the following theoretical structure polymer (IV).

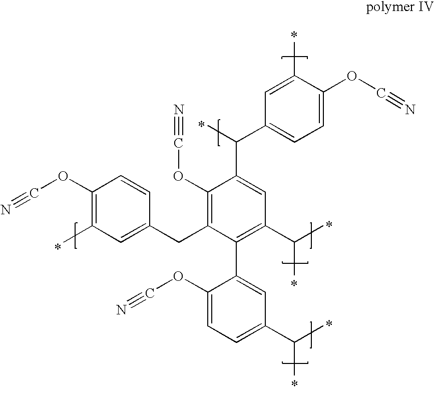

During a manufacturing process, a reaction mixture obtained may include unwanted materials, such as salts, unreacted and excess base, and carrier solvent. Further processing or purifying may be performed to remove the unwanted materials and/or isolate a product polymer (IV). Purifying may be accomplished by dissolving the resin in a suitable solvent such as benzene, toluene, xylene, alcohol, and the like, and washing several times with water, and separating the aqueous and organic layers. Solvent may be distilled off or away. A reaction product or polymer composition may be purified further by dissolving in acetone or alcohol, filtering off any solid impurities and evaporating the solvent. A polymer composition produced by this or similar method may have an equivalent weight of less than about 100, within a range of from about 100 to about 150, and more from about 150 to about 200, from about 200 to about 250, from about 250 to about 300, or greater than about 300. In the illustrated embodiment, an equivalent weight may be about 130.

In one embodiment, a cyanate ester functionalized resin based upon the polymer (I) polyhydroxystyrene may be formed according to the above method. A resulting product may be a solid at room temperature, with a relatively high molecular weight, a relatively low epoxide equivalent, and a relatively high functionality.

In one embodiment, a cyanate ester functionalized resin based upon the polymer (II) polyhydroxystyrene may be formed according to the above method. A resulting product may be a solid at room temperature, with a relatively high molecular weight, a relatively low epoxide equivalent, and a relatively high functionality.

In one embodiment, a cyanate ester functionalized resin based upon the polymer (III) polyhydroxystyrene may be formed according to the above method. A resulting product may be a solid at room temperature, with a relatively high molecular weight, a relatively low epoxide equivalent, and a relatively high functionality.

In one embodiment, a cyanate ester functionalized resin based on a combination of two or more of polyhydroxystyrene polymers (I), (II) or (III) may be formed according to the above method. A resulting product may be a solid at room temperature, with a relatively high molecular weight, a relatively low epoxide equivalent, and a relatively high functionality.

In one embodiment, a reactant product produced by the above disclosed method may include a high functionality cyanate ester resin, with a pre-cure (monomeric) viscosity in a range of from about a water-like liquid to a honey-like liquid. Water has an absolute or dynamic viscosity at about room temperature of about 1 centipoise; and, honey has a viscosity at about 25 degrees Celsius and about 13.5 percent water content of about 420 poise. In one embodiment, a viscosity may be in a range of from about 0.5 centipoise, from about 0.5 centipoise to about 1 centipoise, from about 1 centipoise to about 10 centipoise, from about 10 centipoise to about 100 centipoise, from about 100 centipoise to about 500 centipoise, from about 500 centipoise to about 1 poise, from about 1 poise to about 100 poise, from about 100 poise to about 500 poise, or greater than about 500 poise. A cyanate ester functionalized polyhydroxystyrene according to one embodiment may have an average functionality of less than about 5, in a range of from about 5 to about 25, from about 25 to about 50, from about 50 to about 75, from about 75 to about 100, or greater than about 100.

Functionalization of polyhydroxystyrene may produce, for example, a polymer (IV) with a high molecular weight, and a controlled equivalent weight and functionality. In one embodiment, functionalized polyhydroxystyrene may be solid at room temperature and must be heated for liquefaction. Liquefaction may allow for dispersion of a catalyst, an additive, or the like therein. In one embodiment, the lowered viscosity associated with liquefaction may allow for injection into a mold, wetting of reinforcing fibers, flow for processing, and the like, and combinations of two or more thereof.

In a second embodiment of the invention, a composition may be formed by a cross functionalization of low molecular weight polyhydric-molecules, such as di-hydric phenols, with polyhydroxystyrene, and functionalizing the product in a manner that is the same, or substantially the same, as disclosed herein. Suitable di-hydric phenols may include single ring pheonols, such as hydroquinone, resorcinol, catechol; bisphenols, such as bisphenol A, bisphenol E, bisphenol F, bisphenol M, and the like; and, halogenated derivatives of the foregoing, such as hexafluorobisphenol A, and the like; and, combinations of two or more thereof. In one embodiment, di-hydric phenols may include one or both of hydroquinone and resorcinol, each having a molecular weight of 110. Structures of hydroquinone and resorcinol are shown below.

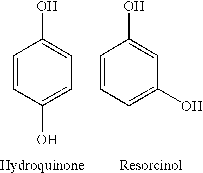

Suitable polyhydroxystyrene compositions for use in a second embodiment according to the invention may include polymers (I), (II) and (III), disclosed above.

Reaction of di-hydric phenols with polyhydroxystyrene, and functionalizing with cyanogen chloride in the presence of an alkali, may form pre-polymer product having a predetermined molecular weight and/or equivalent weight. Di-hydric phenol and polyhydroxystyrene may be present in a molar ratio of less than about (100:1), in a range of from about 1 to about 0.01 (100:1), from about 2 to about 1 (2:1), or greater than about 2. In one embodiment, a ratio of di-hydric phenol to polyhydroxystyrene may be based on available hydroxyl equivalents, that is, for every available hydroxyl group on a polyhydroxystyrene, about one di-hydric phenol may be present. In one embodiment, an average functionality of less than about 5, in a range of from about 5 to about 25, from about 25 to about 50, from about 50 to about 75, from about 75 to about 100, from about 100 to about 200, from about 200 to about 300, or greater than about 300, may be obtained.

While the exact structural formulas for the various polymer products of this embodiment may be not known, they may be represented as having the following theoretical structural formula polymer (V):

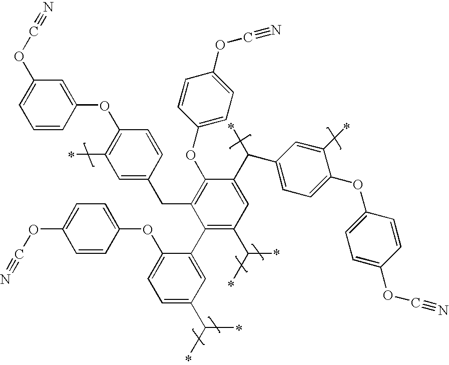

Compositions comprising reaction products according to this embodiment, may exhibit relatively high functionality at relatively low viscosity, may include one or more ether linkage between an aromatic group of the polyhydroxystyrene and of the di-hydric phenol. In one embodiment, a presence of ether linkages may impart toughness and flexibility, and may optionally enhance chemical resistance and/or thermal resistance. A polymer composition produced by this or similar method may have an equivalent weight of less than about 100, within a range of from about 100 to about 150, and more from about 150 to about 200, from about 200 to about 250, from about 250 to about 300, or greater than about 300. In the illustrated embodiment, an equivalent weight may be about 220.

In both of the previously described processes for forming cyanate ester functionalized polymers IV and V, it may be desirable to control the temperature of the reaction medium. Prior to, or during the early phase of a reaction, it may be desirable to heat the system to a temperature above ambient temperature, particularly to control or reduce viscosity. Because of an exothermic nature of some curing reactions, a cooling system may be provided to ensure that the system does not reach an excessively high temperature.

Cyanate ester resins or polymers prepared in accordance with this method may be cured with one or more curing agents, which may include tertiary, secondary or primary amines, anhydrides, acids, lewis acids, lewis bases, amides, imidizoles, ureas, and other curing agents and/or catalysts. Particularly, suitable curing agents may include one or more of imidazoles, such as 2-methylimidazole, 2-undecylimidazole, 2-heptadecyl imidazole, 2-phenylimidazole, 2-ethyl-4-methylimidazole, 1-benzyl-2-methylimidazole, 1-propyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-guanaminoethyl-2-methylimidazole and addition products of an imidazole and trimellitic acid; tertiary amines, such as N,N-dimethyl benzylamine, N,N-dimethylaniline, N,N-dimethyltoluidine, N,N-dimethyl-p-anisidine, p-halogeno-N,N-dimethylaniline, 2-N-ethyl anilino ethanol, tri-n-butylamine, pyridine, quinoline, N-methyl morpholine, triethanolamine, triethylene diamine, N,N,N′,N′-tetramethyl butanediamine, N-methyl piperidine; or phenols, such as phenol, bisphenol, cresol, xylenol, resorcinol, hydroquinone, catechol, and phloroglucin.

Other suitable curing agents or co-catalysts may include one or more of urea, polyol, or epoxide. Commercially available polyol suppliers may include Bayer MaterialScience Corporation (Pittsburgh, Pa.), Ferro Corp (Evansville, Ind.), and BP Amoco Polymers Inc. (Alpharetta, Ga.). Suitable polyols may include linear polypropylene polyethylene ether polyol, which is commercially available as ACCLAIM 2200 N from Bayer; 1,4-butanediol, neopentyl glycol polyester, which is commercially available as LEXOREZ 1640-55R from Inolex Chemical Company (Philadelphia, Pa.); and, CAPA brand capalactone and polyol, which are commercially available from Solvay Corporation (Brussels, Belgium).

Suitable epoxide curing agents may include bi-functional compounds, such as resorcinol diglycidal ether (RDGE) and bismaleimide (BMI). Multi-functional epoxides, when present, may increase toughness by, for example, modifying an initially formed aryl cyanurate to an alkyl cyanurate, and further modify to an alkyl isocyanurate. Available ketone groups in an alkyl isocyanurate may allow for further crosslinking as the aromatic ring becomes cycloaliphatic (allowing for configuration variations beyond linear).

Suitable catalysts may include one or more of organic metal salts, such as lead naphthenate, lead stearate, zinc naphthenate, zinc octoate, tin oleate, dibutyl tin maleate, manganese naphthenate, cobalt naphthenate, and acetyl acetone iron; and inorganic metal salts, such as stannic chloride, zinc chloride and aluminum chloride; peroxides, such as benzoyl peroxide, lauroyl peroxide, octanoyl peroxide, acetyl peroxide, para-chlorobenzoyl peroxide and di-t-butyl diperphthalate; acid anhydrides, such as maleic anhydride, phthalic anhydride, lauric anhydride, pyromellitic anhydride, trimellitic anhydride, hexahydrophthalic anhydride, hexa hydropyromellitic anhydride and hexa hydrotrimellitic anhydride; azo compounds, such as azoisobutylonitrile, 2,2′-azobispropane, m,m′-azoxystyrene, hydrozones, and the like. In one embodiment, a catalyst includes carboxylate salt and/or a chelate of a transition metal ion. Such metal ions may help coordinate trimerization during cure. That is, aid in cure via addition polymerization reaction to produce a heterocyclic ring or triazine. Suitable metal catalysts may include one or more of cobalt octoate, cobalt naphthenate, zinc naphthenate, copper acetyl acetonate (AcAc), cobalt (II) AcAc, and cobalt (III) AcAc. In one embodiment, a catalyst may include METACURE T-131, which is commercially available from Air Products and Chemicals, Inc. (Allentown, Pa.). A structure of cobalt octate is shown below.

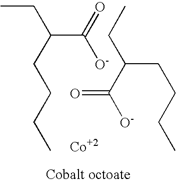

In one embodiment, an accelerator or hardener may include one or more of acid catalysts, hardeners, or nitrogen-based accelerators. Acid catalysts such as phosphoric acid or the morpholine salt of p-toluenesulfonic acid may be used to accelerate the cure. In one embodiment, dicyandiamide, aromatic-amine, polyamide aminoamide, aliphatic-amine, and the like, and combinations of two or more thereof may be used.

In one embodiment, a metal catalyst used alone may result in an unacceptably long cure time. A co-catalyst, and/or a curing agent, may be used in addition to the catalyst. In one embodiment, a metal catalyst may be premixed with a functionalized polyhydroxystyrene according to embodiments of the invention, and may have an extended shelf life, even at elevated temperatures. Thus, in one embodiment, a co-catalyst or curing agent may be added to a pre-catalyzed functionalized polyhydroxystyrene directly before polymerization. Pre-heating a pre-catalyzed functionalized polyhydroxystyrene may lower viscosity the working viscosity, for example, in preparation of injection into a mold. In one embodiment, pre-heating may be performed such that the working or injection temperature of the pre-catalyzed functionalized polyhydroxystyrene is maintained below a cured temperature of the pre-catalyzed functionalized polyhydroxystyrene. Adding a curing agent to a pre-heated and pre-catalyzed functionalized polyhydroxystyrene may reduce the polymerization or cure temperature and, naturally, initiate polymerization.

A curing agent may have a relatively low viscosity to aid in flow and wetting. That is, during mixing of a curing agent and the pre-heated and pre-catalyzed functionalized polyhydroxystyrene the viscosity of the mix may be lowered further by the addition of the addition of the low-viscosity curing agent. Such relatively low viscosity may increase the uniformity of mixing in, for example, a nozzle, may increase flow rate, may increase impregnation rate, may increase wetting, and may aid in degassing during processing, such as reaction injection molding, and the like.

Suitable processing equipment may include equipment for sheet casting, reaction injection molding, compression molding, vacuum assisted bag molding, SCRIM molding (non-woven open-weave reinforcing fabric made from continuous filament yarn in an open mesh construction), resin transfer molding (RTM), plural spray molding, sheet transfer molding, and the like, and combinations of two or more thereof. In one embodiment, process equipment may include reaction injection molding, liquid reaction molding or high-pressure impingement mixing. Suitable RIM processing equipment may be commercially obtainable at Gussman Corporation (Lakewood, N.J.), for example the model DELTA RIM and RIMCELL series.

A cured polymer product produced using a composition according to the invention may have a relatively increased chemical resistance, temperature resistance, toughness, durability, and degree of cross-linking. In one embodiment, a cured polymer product may have a glass transition temperature of less than about 100 degrees Celsius, in a range of from about 100 degrees Celsius to about 200 degrees Celsius, from about 200 degrees Celsius to about 300 degrees Celsius, from about 300 degrees Celsius to about 400 degrees Celsius, or greater than about 400 degrees Celsius. In one embodiment, a cured polymer product may have a molecular weight of less than about 10,000, in a range of from about 10,000 to about 15,000, from about 15,000 to about 20,000, or greater than about 20,000.

A composite product formed by a method according to the invention may have one or more improved properties relative to characteristic ranges attributed to bismaleimide (BMI) or epoxy comparative products. Such properties may include one or more of flame resistance, temperature resistance, dimensional stability, low-smoke generation, low water absorption, increased cross-link density, increased chemical resistance (solvent, acid, and/or caustic), adhesion strength, thermal endurance, physical damage resistance/impact resistance, reduced out-gassing, reduced risk of allergic reaction, reduced galvanic corrosion of metal-coated substrates, increased dielectric strength, low dielectric constant (Dk), reduced dissipation factor (Df, loss tangent), reduced reflectance of radiation, increased range or signal strength over relatively broader bandwidth and through thicker composite widths, improved signal transmission quality, radiation damage resistance, ultraviolet light resistance, higher refractive index, or reduced signal loss or attenuation. In one embodiment, a cured product, with or without fiber reinforcement, may have one or more of a relatively increased glass transition temperature relative to glass transition temperatures associated with BMI and epoxy-based products, reduced hydrogen bonding functionality (improved dielectric properties), increased strain energy release rate, or tensile elongation.

### EXAMPLES

The following examples illustrate methods and embodiments in accordance with the invention, and as such should not be construed as imposing limitations upon the claims. Unless specified otherwise, all ingredients are commercially available from such common chemical suppliers as Alpha Aesar, Inc. (Ward Hill, Mass.) and/or Spectrum Chemical Mfg. Corp. (Gardena, Calif.).

### Example 1

A solution of 1000 grams of polyhydroxystyrene PG (1000 g×1 mol/6000 g is 0.16 mol) having an equivalent weight of 130 (1000 g×1 ew/130 g is 7.7 normal (ew)) is prepared in 25 liters of acetone. The solution is cooled to 0 degrees Celsius and stirred until dissolved. To the stirring solution, 8 mol (61.5 g/mol×8 mol is 492 g) of cyanogen chloride is added to form a mixture. This provides an excess of cyanogen chloride per hydroxyl on the polyhydroxystyrene. Shortly thereafter, and while still stirring, 7.7 moles of triethylamine is added to the mixture, simultaneously, the mixture is cooled to maintain a mixture temperature in a range of from about 0 degrees Celsius to less than about 10 degrees Celsius. After about 10 minutes of reaction time, stirring is stopped and the product is filtered. Filtering removes triethylammonium chloride salt. Filtering is accomplished by triple rinsing with about a liter of acetone. Residual acetone and cyanogen chloride are evaporated and recovered under vacuum. Vacuum distillation of the resulting functionalized polyhydroxystyrene completes recovery.

The resulting functionalized polyhydroxystyrene is heated to reduce viscosity and mixed with a metal catalyst. The temperature is maintained at less than a cure temperature. The catalyzed resin, at the heated reduced viscosity, is then processed in reaction injection molding (RIM) equipment. At the injection nozzle, a plural mixer combines a polyol toughening agent and hydroxyl source with the catalyzed resin. The RIMCELL RX reaction injection molding equipment injects the combined material into the RIM mold having a reinforcing fiber form therein. The presence of the catalyst and the polyol at the injection temperature initiates polymerization (trimerization). A fiber reinforced composite is removed from the RIM mold.

### Example 2

A composition is prepared as in Example 1, except that prior to addition of cyanogen chloride, 8 mol of resorcinol (104 g) is added to the mixture. A condensation reaction is initiated at an elevated temperature, optionally with a catalyst, sufficient to selectively react the resorcinol with the phenoxy group on the polyhydroxystyrene.

The processes and embodiments described herein may be examples of chemical structures, systems, compositions, and methods having elements corresponding to the elements of the invention recited in the claims. This written description may enable those skilled in the art to make and use embodiments having alternative elements that likewise correspond to the elements of the invention recited in the claims. The intended scope of the invention thus includes other chemical structures, systems, compositions and methods that do not differ from the literal language of the claims, and further includes other chemical structures, systems, compositions and methods with insubstantial differences from the literal language of the claims.

What is claimed is:

1. A pre-polymer composition, comprising a reaction product of polyhydroxystyrene and cyanogen halide, wherein the product comprises a plurality of cyanate ester moieties.

2. The composition as defined in claim 1, wherein the reaction product further comprises a polyol.

3. The composition as defined in claim 2, wherein the polyol comprises one or more di-hydric phenol.

4. The composition as defined in claim 3, wherein the di-hydric phenol is hydroquinone or resorcinol.

5. The composition as defined in claim 1, wherein the polyhydroxystyrene comprises one or more of polyhydroxystyrene PG, polyhydroxystyrene PG-L, or polyhydroxystyrene novolak.

6. The composition as defined in claim 5, wherein the polyhydroxystyrene has the structural formula of polymer (I):

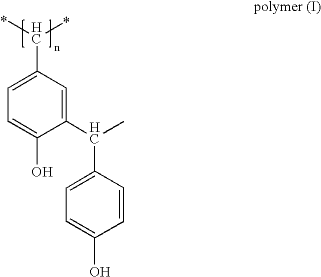

7. The composition as defined in claim 5, wherein the polyhydroxystyrene has the structural formula of polymer (II):

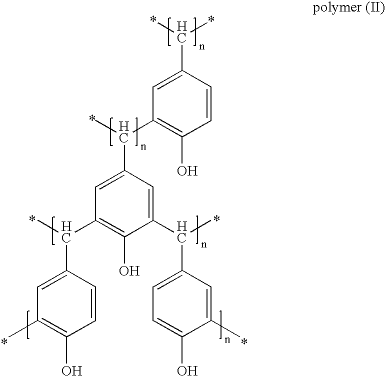

7. The composition as defined in claim 5, wherein the polyhydroxystyrene has the structural formula of polymer (III):

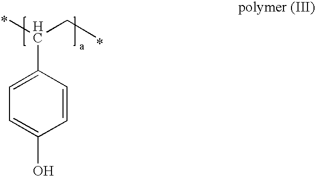

8. The composition as defined in claim 1, wherein the reaction product has the structural formula of polymer (IV):

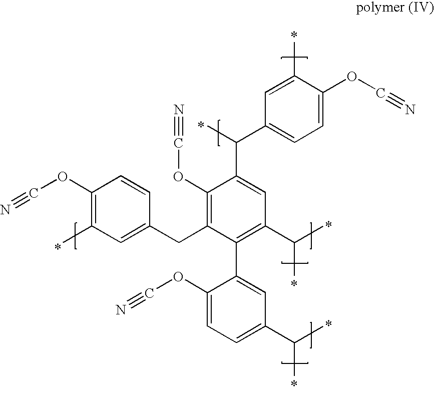

9. The composition as defined in claim 1, wherein the reaction product has the structural formula of polymer (V):

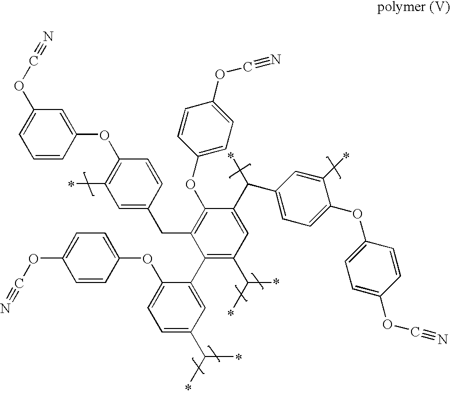

10. A cured polymer product, comprising the reaction product as defined in claim 1, a catalyst, and curing agent.

11. The cured polymer product as defined in claim 10, wherein the catalyst comprises an organic metal salt, the curing agent comprises a polyol, or both the catalyst comprises an organic metal salt and the curing agent comprises a polyol.

12. A cured polymer product, comprising the reaction product as defined in claim 2, a catalyst, and curing agent.

13. The cured polymer product as defined in claim 12, wherein the catalyst comprises an organic metal salt, the curing agent comprises a polyol, or both the catalyst comprises an organic metal salt and the curing agent comprises a polyol.

14. A method of making a functionalized polymer composition, comprising:
mixing solutes into a solvent to form a solution, the solutes comprising at least polyhydroxystyrene and cyanogen halide;
adding a base to the solution; and
reacting the solutes to form the functionalized polymer composition.

15. The method as defined in claim 14, wherein the base comprises triethylamine.

16. The method as defined in claim 14, wherein the cyanogen halide comprises cyanogen chloride.

17. The method as defined in claim 14, wherein the solutes further comprise a polyol.

18. The method as defined in claim 15, wherein the polyol comprises one or more di-hydric phenol.

20. The method as defined in claim 14, wherein the molar ratio of polyhydroxystyrene to cyanogen halide is in a range of from about 2 moles to about 10 moles excess cyanogen halide.

21. The method as defined in claim 14, wherein the reaction product has an equivalent weight in a range of from about 100 to about 500.

22. A method of making a composite article in a reaction injection mold (RIM) apparatus, comprising:
mixing a reaction product of polyhydroxystyrene and cyanogen halide with a catalyst to form a catalyzed cyanate ester pre-polymer;
mixing the catalyzed cyanate ester pre-polymer with a curing agent in a nozzle of the RIM apparatus; and
injecting the mixture of the catalyzed cyanate ester pre-polymer and curing agent into a mold of the RIM apparatus.
